(19) United States
(12) Patent Application Publication
(10) Pub. No.: US 2017/0249406 A1
(43) Pub. Date: Aug. 31, 2017

(54) CUSTOMIZED LUMBAR SPINE RESPONSE FINITE ELEMENT MODEL FOR CRASH TEST DUMMY AND METHOD

(71) Applicant: Humanetics Innovative Solutions, Inc., Plymouth, MI (US)

(72) Inventor: Chirag Shah, Plymouth, MI (US)

(21) Appl. No.: 15/445,498

(22) Filed: Feb. 28, 2017

Related U.S. Application Data
(60) Provisional application No. 62/301,401, filed on Feb. 29, 2016.

(51) Int. Cl. G06F 17/50

(52) U.S. Cl. CPC G06F 17/5018; G06F 2217/14; G06F 2217/16

(57) ABSTRACT

A customized lumbar spine response finite element model for a lumbar spine of a crash test dummy is disclosed. A method of creating the customized lumbar spine response finite element model for the lumbar spine of the crash test dummy includes the steps of identifying two borderline sets of test data profiles for the lumbar spine that match with extreme test data profiles of the lumbar spine of the crash test dummy, varying material properties of the lumbar spine for the crash test dummy, defining a mapping function to adjust the material properties and allowing intermediate sets of the test data profiles to be interpolated from the extreme test data profiles, and creating a single lumbar spine response finite element model for the lumbar spine of the crash test dummy with a user-defined input parameter for the lumbar spine response finite element model that defines a customized response.

### CROSS-REFERENCE TO RELATED APPLICATION(S)

The present application claims the benefit of pending U.S. Provisional Patent Application Ser. No. 62/301,401, filed Feb. 29, 2016, the entire disclosure of which is hereby expressly incorporated by reference.

### BACKGROUND OF THE INVENTION

1. Field of the Invention

The present invention relates generally to crash test dummies and, more particularly, to a customized lumbar spine response finite element model for a crash test dummy and method of creating the customized lumbar spine response finite element model.

2. Description of the Related Art

Automotive, aviation, and other vehicle manufacturers conduct a wide variety of collision testing to measure the effects of a collision on a vehicle and its occupants. Through collision testing, a vehicle manufacturer gains valuable information that can be used to improve the vehicle, authorities examine vehicles to submit type approval, and consumer organizations provide information on vehicle safety ratings to the public.

Collision testing often involves the use of anthropomorphic test devices, better known as “crash test dummies”, to estimate a human's injury risk. The dummy must possess the general mechanical properties, dimensions, masses, joints, and joint stiffness of the humans of interest. In addition, they must possess sufficient mechanical impact response similitude and sensitivity to cause them to interact with the vehicle's interior in a human-like manner.

The crash test dummy typically includes a head assembly, spine assembly (including neck), rib cage assembly, abdomen, lumbar spine, pelvis assembly, right and left arm assemblies, and right and left leg assemblies. Generally, the arm assembly has an upper arm assembly and a lower arm assembly. The upper arm assembly is typically connected to a shoulder assembly, which, in turn, is typically connected to the spine assembly.

Currently, there is dummy-to-dummy variability seen in lumbar spine performance of physical crash test dummies in sled and vehicle testing due to differences in materials, manufacturing, and environment. As a result, there is a need in the art for a lumbar spine finite element model to enable users to adjust a stiffness of a lumbar spine based on their hardware or physical crash test dummy so as to quantify its characteristics from a controlled lumbar spine component testing level to their sled or vehicle environment. There is also a need in the art for a lumbar spine finite element model that not only captures a phenomenon of variability, but also allows users to perform robustness studies using extremes of variability. Thus, there is a need in the art for a customized lumbar spine response finite element model for a crash test dummy and method of creating the customized lumbar spine response finite element model that meets at least one of these needs.

### SUMMARY OF THE INVENTION

Accordingly, the present invention provides a customized lumbar spine response finite element model for a lumbar spine of a crash test dummy. The present invention also provides a method of creating the customized lumbar spine response finite element model for the lumbar spine of the crash test dummy including the steps of identifying two borderline sets of test data profiles for the lumbar spine that match test data profiles of the lumbar spine for the crash test dummy, varying material properties of the lumbar spine for the crash test dummy, defining a mapping function to adjust the material properties and allowing intermediate sets of the test data profiles to be interpolated from the test data profiles, and creating a single lumbar spine response finite element model for the lumbar spine of the crash test dummy with a user-defined input parameter for the lumbar spine response finite element model that defines a customized response.

One advantage of the present invention is that a new customized lumbar spine response finite element model and method is provided for a crash test dummy. Another advantage of the present invention is that the customized lumbar spine response finite element model and method provides a customized lumbar spine finite element model that bridges a gap between reality and simulation by better capturing hardware behavior, and lays a framework for future models applicable to other parts. Yet another advantage of the present invention is that the customized lumbar spine response finite element model and method enables users to adjust a stiffness and contact algorithm parameters of a lumbar spine so as to quantify its characteristics from the lumbar spine component level to their sled or vehicle environment. Still another advantage of the present invention is that the customized lumbar spine response finite element model and method not only captures the phenomenon of variability, but also allows users to perform robustness studies using extremes of variability corridors.

Other features and advantages of the present invention will be readily appreciated, as the same becomes better understood, after reading the subsequent description taken in conjunction with the accompanying drawings.

### BRIEF DESCRIPTION OF THE DRAWINGS

FIG. 1 is an elevational view of one embodiment of a crash test dummy.

FIGS. 2A-2C are diagrammatic views of a customized lumbar spine response finite element model in flexion, extension, and oblique, respectively, according to one embodiment of the present invention, for the crash test dummy of FIG. 1.

FIG. 3 is an elevational view of an apparatus for lumbar spine impact testing for creating the customized lumbar spine response finite element model, according to the present invention, for the crash test dummy of FIG. 1.

### DESCRIPTION OF THE PREFERRED EMBODIMENT(S)

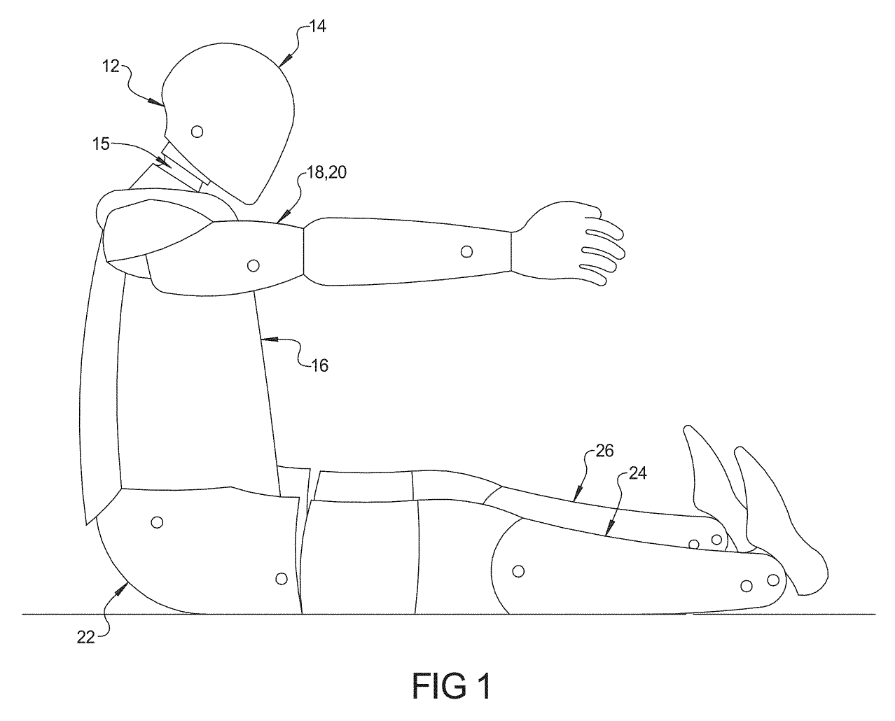

Referring to the drawings and in particular FIG. 1, one embodiment of a crash test dummy, according to the present invention, is generally indicated at 12. The crash test dummy 12 is of a fiftieth percentile (50%) male type and is illustrated in a seated position. This crash test dummy 12 is used primarily to test the performance of automotive interiors and restraint systems for front and rear seat occupants. The size and weight of the crash test dummy 12 are based on anthropometric studies, which are typically done separately by the following organizations, University of Michigan Transportation Research Institute (UMTRI), U.S. Military Anthropometry Survey (ANSUR), and Civilian American and European Surface Anthropometry Resource (CESAR). It should be appreciated that ranges of motions, centers of gravity, and segment masses simulate those of human subjects defined by the anthropometric data.

As illustrated in FIG. 1, the crash test dummy 12 includes a head assembly, generally indicated at 14. The crash test dummy 12 also includes a neck assembly, generally indicated at 15, having an upper end mounted to the head assembly 14 and a lower end mounted to a spine assembly (not shown) extending into a torso area of the crash test dummy 12.

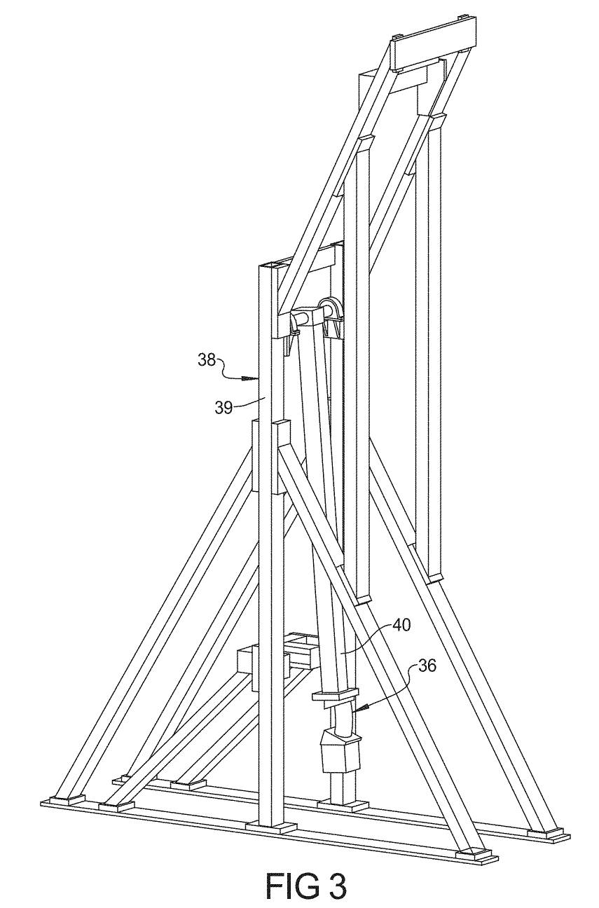

The torso area of the crash test dummy 12 also includes a rib cage or torso assembly, generally indicated at 16, connected to the thorax and the spine assembly. A lower end of the spine assembly is connected to a lumbar spine assembly 36 (FIG. 3). The crash test dummy 12 also has a pair of arm assemblies including a right arm assembly, generally indicated at 18, and a left arm assembly, generally indicated at 20, which are attached to the spine assembly of the crash test dummy 12. It should be appreciated that the lower end of the spine assembly is connected to the lumbar spine assembly 36 (FIG. 3), which is connected to a pelvic adapter (not shown). It should be appreciated that the neck assembly 15 is connected to an upper end of the spine assembly. It should further be appreciated that an example of a lumbar spine assembly for a crash test dummy is disclosed in U.S. patent application Ser. No. 14/980,655, filed Dec. 28, 2015, to Been, the disclosure of which is hereby incorporated in its entirety by reference.

As illustrated in the FIG. 1, the crash test dummy 12 includes a pelvis assembly, generally indicated at 22, connected to the adapter. The crash test dummy 12 includes a right leg assembly 24 and a left leg assembly 26, which are attached to the pelvis assembly 22. It should be appreciated that various components of the crash test dummy 12 may be covered in a polyvinyl skin such as a flesh and skin assembly for biofidelity of the crash test dummy 12.

One embodiment of a customized lumbar spine response finite element model 30, according to the present invention, is disclosed for the crash test dummy 12. The model 30 is to be carried out on a computer system that includes a computer having a memory, a processor, a display and user input mechanism, such as a mouse or keyboard (not shown). The model 30 is implemented on the computer system in MATLAB, which is commercially available from MathWorks, coupled with other lower level languages. Efficient numerical algorithms (Genetic Algorithm) are used and coded, making it possible that a complete analysis can be done within minutes on a Pentium computer of the computer system. It should be appreciated that the computer system is conventional and known in the art.

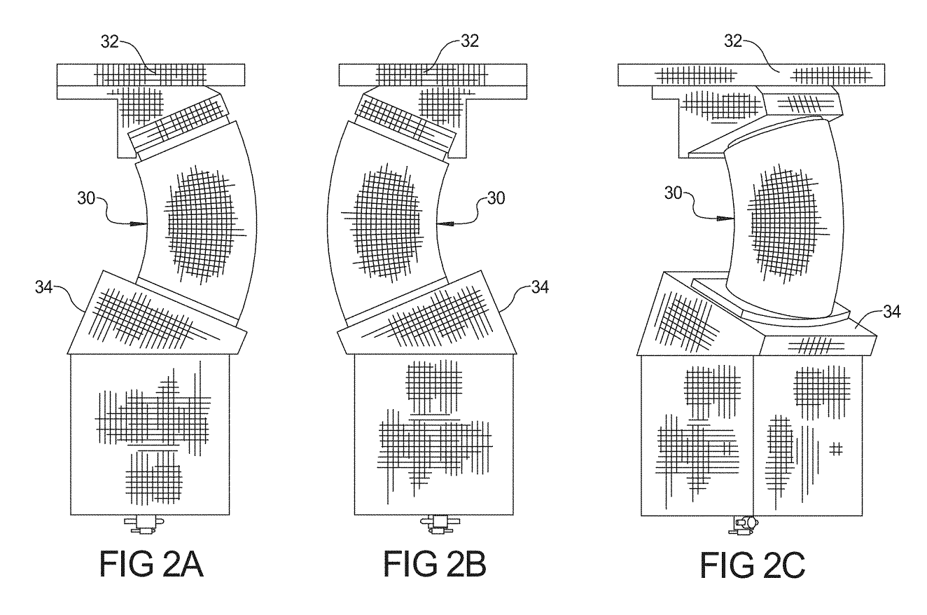

Referring to FIGS. 2A-2C, one embodiment of a customized lumbar spine response finite element model, according to the present invention and generally indicated at 30, is disclosed for the lumbar spine assembly 36 of the crash test dummy 12. The lumbar spine response finite element model 30 represents the lumbar spine assembly 36 of the crash test dummy 12, which in turn, represents a human lumbar spine. The lumbar spine response finite element model 30 is disposed between an upper thoracic assembly 32 of the spine assembly and a thoracic spine load cell 34 of the spine assembly. The customized lumbar spine response finite element model 30 includes a lumbar rubber and a lumbar cable (not shown) representing nominal, soft, and stiff response of the lumbar spine assembly 36 for the lumbar spine response finite element model 30. To construct the customized lumbar spine response finite element model 30, all levels of lumbar spine correlation are evaluated to ensure that the response was reasonable. It should be appreciated that the lumbar spine hardware of the crash test dummy 12 includes complex structural components involving rubber segments, cable, and transducers to measure the force and moment arm lumbar spine measurements. It should also be appreciated that the lumbar spine response finite element model 30 may include additional components (not shown) such as a lumbar spine flex joint (not shown) disposed between the thoracic spine load cell and the pelvis/lumbar spine mounting block.

Referring to FIG. 3, an apparatus, generally indicated 38, for a lumbar spine impact testing or a pendulum certification test for the lumbar spine assembly 36 of the crash test dummy 12 is shown. The apparatus 38 includes a frame 39 for the lumbar spine assembly 36. The apparatus 38 also includes a pendulum 40 pivotally connected to the frame 39. As illustrated, the pendulum 40 has one end that produces the flexion of the lumbar spine assembly 36 for the finite element model 30 illustrated in FIG. 2A, the extension of the lumbar spine assembly 36 for the finite element model 30 illustrated in FIG. 2B, and oblique of the lumbar spine assembly 36 for the finite element model 30 illustrated in FIG. 2C. In one embodiment, the pendulum 40 produces impact tests for the lumbar spine assembly 36 at predetermined speeds.

For creating the customized lumbar spine response finite element model 30, a method, according to the present invention, includes the steps of identifying two borderline sets of test data profiles of the lumbar spine assembly 36 that match reasonably well with extreme test data profiles of the lumbar spine assembly 36 from the testing with the apparatus 38. For example, two borderline sets of the test data profiles that match with variability at controlled component testing of the lumbar spine assembly 36 were identified. For example, minimizing the peak value differences between the test and finite element model values. It should be appreciated that the smaller a gap (error) between two values, the better the model is. It should also be appreciated that, in principle, the target is to match the model and test peak values exactly.

The method also includes the steps of varying material properties of key components of the lumbar spine assembly 36 and/or varying finite element contact parameters such as contact friction of the components of the lumbar spine assembly 36. For example, varying material properties of a joint of the lumbar spine assembly 36. Then, the method includes the step of defining a mapping function to adjust the material properties and allowing intermediate sets of the test data profiles to be interpolated from the extremes of the test data profiles, thus matching a best match to any level. For example, the mapping function adjusts the materials such as material properties and contacts such as contact parameters in the finite element model 30 to minimize the gap (error) between the input test peak value and the output test peak value of the same parameter in the model.

The method also includes the steps of creating a single lumbar spine response finite element model 30 for the crash test dummy 12 with a user-defined ‘input parameter’ for the lumbar spine response finite element model 30 that defines a ‘customized’ response, which is equal to a lumbar spine moment arm peak of the lumbar spine assembly 36. The lumbar spine response finite element model 30 then internally calibrates material cards of the lumbar spine assembly 36 using a parameter script to reproduce a lumbar spine moment arm of the lumbar spine assembly 36 within 0.5 Nm accuracy of a specified input. The lumbar spine moment is set between a maximum value and a minimum value with a default value to an average value of the moment for the lumbar spine pendulum tests for the lumbar spine assembly 36 of the crash test dummy 12. In one embodiment, the lumbar spine moment is a default value corresponding to an average value of lumbar spine extension or flexion certification tests of the lumbar spine assembly 36 for the crash test dummy 12. It should be appreciated that a default (example) value will be in the middle of the certification corridors. It should be appreciated that a focus in development was in a lumbar spine pendulum case where there was a larger variety of data which ensured that the finite element model 30 captured a wide range of physical test dummies such as the crash test dummy 12. It should also be appreciated that a method of modeling for crash test dummy finite element models is disclosed in U.S. Pat. No. 9,043,187 to Pang, the disclosure of which is hereby incorporated in its entirety by reference.

As previously described, there is dummy-to-dummy variability seen in the lumbar spine of physical dummies (sled and vehicle tests) such as the crash test dummy 12 due to differences in material, manufacturing, environment, aging effect and other factors. The customized lumbar spine response finite element model 30 allows adjustment of a stiffness of lumbar spine assembly 36 based on the physical hardware of the crash test dummy 12, which might range from stiff at one end to soft at another end. It should be appreciated that this customization, based on test data from physical crash test dummy 12, enables the user to accurately quantify or predict the lumbar spine moment arm of the lumbar spine assembly 36 of the crash test dummy 36 at the sled or vehicular level. It should also be appreciated that a system for modeling dynamic response changes in an anthropomorphic dummy is disclosed in U.S. Pat. No. 8,407,033 to Cooper et al., the disclosure of which is hereby incorporated in its entirety by reference.

The method may also include the step of varying finite element contact algorithm parameters of the lumbar spine response finite element model 30 for components of the lumbar spine assembly 36. For example, the finite element contact parameters are a coefficient of friction. It should be appreciated that this parameter controls the resistance (force) when the two finite element model surfaces are rubbed (or slid) against each other.

The reliability of the customized lumbar spine response finite element model 30 was validated across numerous component, sled and vehicle load cases. It should be appreciated that, although the customized lumbar spine response finite element model 30 was developed for a particular brand of crash test dummies 12, through customization, it can accurately represent the moment for any lumbar spine for the crash test dummy 12.

In one embodiment, a method, according to the present invention, of creating a customized lumbar spine response finite element model 30 for a lumbar spine of the crash test dummy 12 includes the steps of identifying two borderline sets of test data profiles for the lumbar spine that match with extremes of test data profiles of the lumbar spine for the crash test dummy 12, varying material properties of the lumbar spine for the crash test dummy 12, defining a mapping function to adjust the material properties and allowing intermediate sets of test data profiles to be interpolated from the test data profiles, and creating a single lumbar spine response finite element model 30 for the lumbar spine of the crash test dummy 12 with a user-defined input parameter for the lumbar spine response finite element model 30 that defines a customized response.

The method may also include the steps of internally calibrating material cards for the lumbar spine using a parameter script to reproduce a lumbar spine moment. The method may further include the steps of setting a lumbar spine moment at a maximum value and a minimum value of certification corridors.

Accordingly, the present invention is a customized lumbar spine finite element dummy model 30 that can precisely represent any physical crash test dummy 12 giving better control of lumbar spine moment. The customized lumbar spine response finite element model 30 is a first of its kind model that bridges the gap between reality and simulation by taking variability into account. In addition, the customized lumbar spine response finite element model 30 provides the framework for future finite element models and can be applied to other parts to better capture hardware behavior of the crash test dummy 12.

The present invention has been described in an illustrative manner. It is to be understood that the terminology, which has been used, is intended to be in the nature of words of description rather than of limitation.

Many modifications and variations of the present invention are possible in light of the above teachings. Therefore, the present invention may be practiced other than as specifically described.

What is claimed is:

1. A method of creating a customized lumbar spine response finite element model for a lumbar spine of a crash test dummy, said method comprising the steps:
identifying two borderline sets of test data profiles for the lumbar spine that match with extremes of test data profiles of the lumbar spine for the crash test dummy;
varying material properties of the lumbar spine for the crash test dummy;
defining a mapping function to adjust the material properties and allowing intermediate sets of test data profiles to be interpolated from the test data profiles; and
creating a single lumbar spine response finite element model for the lumbar spine of the crash test dummy with a user-defined input parameter for the lumbar spine response finite element model that defines a customized response.

2. A method as set forth in claim 1 wherein the customized response is equal to a lumbar spine moment peak.

3. A method as set forth in claim 1 including the step of internally calibrating material cards for the lumbar spine using a parameter script to reproduce a lumbar spine moment.

4. A method as set forth in claim 1 wherein the customized lumbar response finite element model has within 0.5 Nm accuracy of a specified input.

5. A method as set forth in claim 1 including the step of setting a lumbar spine moment at a maximum value and a minimum value of certification corridors.

6. A method as set forth in claim 3 wherein the lumbar spine moment is a default value corresponding to an average value of lumbar spine pendulum test response for the crash test dummy.

7. A customized lumbar spine response finite element model for the lumbar spine of the crash test dummy created by the method as set forth in claim 1.

8. A method of creating a customized lumbar spine response finite element model for a lumbar spine of a crash test dummy, said method comprising the steps:
identifying two borderline sets of test data profiles for the lumbar spine that match with extremes of test data profiles of the lumbar spine for the crash test dummy;
varying material properties of the lumbar spine for the crash test dummy;
defining a mapping function to adjust the material properties and allowing intermediate sets of the test data profiles to be interpolated from the test data profiles;
creating a single lumbar spine response finite element model for the lumbar spine of the crash test dummy with a user-defined input parameter for the lumbar spine response finite element model that defines a customized response, wherein the customized response is equal to a lumbar spine moment peak; and
internally calibrating material cards for the lumbar spine using a parameter script to reproduce a lumbar spine moment.

9. A method as set forth in claim 8 wherein the customized lumbar response finite element model has within 0.5 Nm accuracy of a specified input.

10. A method as set forth in claim 8 including the step of setting a lumbar spine moment at a maximum value and a minimum value of certification corridors.

11. A method as set forth in claim 8 wherein the lumbar spine moment is a default value corresponding to an average value of lumbar spine pendulum test response for the crash test dummy.

12. A customized lumbar spine response finite element model for the lumbar spine of the crash test dummy created by the method as set forth in claim 8.

13. A method of creating a customized lumbar spine response finite element model for a lumbar spine of a crash test dummy, said method comprising the steps of:
setting a lumbar spine moment at a maximum value and a minimum value of certification corridors for the lumber spine;
identifying two borderline sets of test data profiles for the lumbar spine that match with extremes of test data profiles of the lumbar spine;
varying material properties of the lumbar spine;
defining a mapping function to adjust the material properties and allowing intermediate sets of the test data profiles to be interpolated from the test data profiles;
creating a single lumbar spine response finite element model for the lumbar spine of the crash test dummy with a user-defined input parameter for the lumbar spine response finite element model that defines a customized response, wherein the customized response is equal to a lumbar spine moment peak and the lumbar spine moment is a default value corresponding to an average value of lumbar spine pendulum test response for the crash test dummy; and
internally calibrating material cards for the lumbar spine using a parameter script to reproduce a lumbar spine moment.

14. A customized lumbar spine response finite element model for the lumbar spine of the crash test dummy created by the method as set forth in claim 13.
